(19) United States
(12) Patent Application Publication
(10) Pub. No.: US 2025/0100066 A1
(43) Pub. Date: Mar. 27, 2025

(54) TIG WELDING ELECTRODE SLEEVE

(71) Applicant: John Stelmach, Prescott, AZ (US)

(72) Inventor: John Stelmach, Prescott, AZ (US)

(21) Appl. No.: 18/471,615

(22) Filed: Sep. 21, 2023

(51) Int. Cl. B23K 9/28; B23K 9/14

(52) U.S. Cl. CPC B23K 9/285; B23K 9/14

(57) ABSTRACT

This invention relates to welding processes employing a TIG torch with a non-consumable electrode and a consumable filler rod with the end of the rod being progressively melted by an electric arc generated between the electrode end and the work piece to be welded transferring molten metal from the rod to the melt metal of the work piece (weld puddle) to form a weld joint. Providing a non-consumable arc isolation sleeve guard around the electrode allowing a pre-determined portion of the electrode to be exposed limiting arc variation and wandering.

### BACKGROUND OF THE INVENTION

### 1. Technical Field

The present invention is directed to welding processes, specifically TIG welding that uses a non-consumable electrode to form an arc in a gas shield with a consumable filler rod.

### 2. Description of Prior Art

Prior art welding defines arc welding using a torch type gun with a non-consumable electrode and a consumable filler wire or a rod to form successive droplets of metal which are deposited into a melted metal puddle formed by the arc on the work surface. The nature of the welding in certain situations may impart arc wander where the arc is not properly initiated at the end of the electrode making it difficult to control and thus the consistency of the weld. A number of prior art patents are directed to welding to provide improved welding control by rod holders and welding gun designs, see for example U.S. Pat. Nos. 2,400,285, 2,432,639, 3,536,888 and 5,034,593.

U.S. Pat. No. 2,400,285 is directed to a welding electrode holder having a tubular split jaw member to engage and hold the welding electrode.

U.S. Pat. No. 2,432,639 is directed to a dielectric welding rod holder having a tubular housing of electric insulating material through which a welding rod is inserted and held.

U.S. Pat. No. 3,536,888 claims a splatter free welding gun having a welding wire held within a metal holder with a gas disbursing shield in spaced relation there about with a refractory tube liner.

U.S. Pat. No. 5,034,593 illustrates a coated welding cup having a graphite or ceramic fiber composition coating to enhance resistance to erosion, slagging and thermal fracturing.

### SUMMARY OF THE INVENTION

A non-consumable elongated isolation tubular fitting about a non-consumable electrode used in TIG welding to control the directional parameters and formation of a welding arc between the end of the electrode and the work surface. The isolation fitting is defined by a fitted sleeve formed of ceramic material having a heat diffusing exterior configuration adaptively held on the electrode to a pre-determined positional difference from its free end thereby reducing and eliminating arc wander often found in difficult TIG welding situations caused by arc formation to wander from its preferred end required trajectory.

### DESCRIPTION OF THE DRAWINGS

FIG. 1 is a graphic side elevational view of a generic welding gun with a portion cut away for engagement with a work piece having an electrode isolation sleeve of the invention fitted on the electrode.

FIG. 2 is an enlarged partial side elevational view of the electrode isolation sleeve.

FIG. 3 is an enlarged sectional view of the electrode sleeve fitted on a non-consumable electrode.

FIG. 4 is an enlarged sectional view on lines 4-4 of FIG. 3.

FIG. 5 is an enlarged partial sectional view of an alternate electrode isolation sleeve of the invention with interior spiral engagement rib positioned on a non-consumable electrode.

FIG. 6 is an enlarged graphic illustration of a typical TIG welding electrode indicating arc wandering during use.

FIG. 7 is a graphic enlarged illustration of a TIG electrode within an isolation sleeve of the invention limiting arc welding.

### DETAILED DESCRIPTION OF THE INVENTION

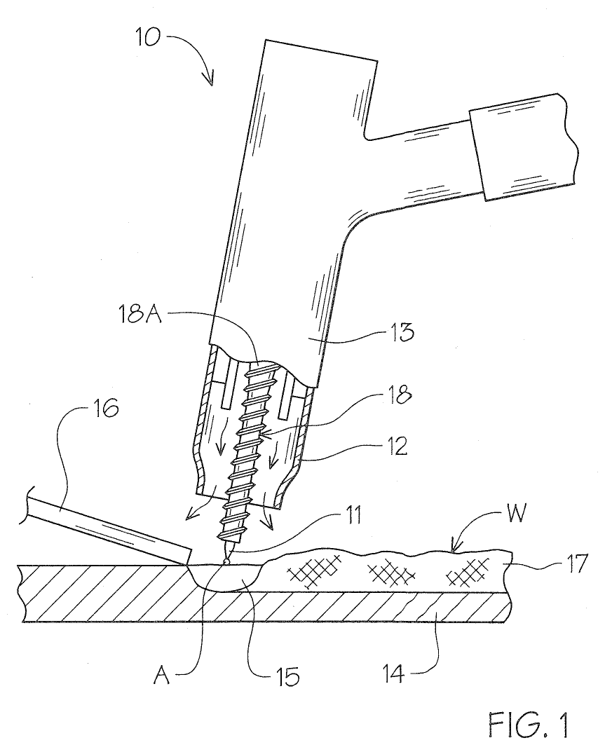

Referring now to FIG. 1 of the drawings, an arc welding torch 10 can be seen having a non-consumable tungsten electrode 11 within an inert gas distribution fitting 12 supported by a main torch body member 13 as is well known and understood in the art. The arc welding torch 10 is used in TIG welding that implements an electric arc A formed between the end of the electrode 11 and a metal work piece 14. TIG welding torch 10 allows for the positioning of the electrode 11 to create a weld W in the work piece 14 by melting metal to form a weld puddle 15 therefrom. A fill rod 16 of weld material is progressively applied to the arc transferring molten metal from the fill rod 16 to the work piece 14 in a sequential globular manner to obtain a continuous weld joint 17.

The key element in TIG welding is control of the electric arc A by directing the electrode 11 along the work piece. Often the arc A wanders due to difficult factors such as shape of the electrode tip 11A or the position of the weld required such as in a confined space.

The arc A consist of a flow of electrons traveling from the end of the electrode 11A to the work piece 14. It is therefore important to mitigate as many variables as possible to reduce the propensity for arc wander.

A non-consumable electrode sleeve 18 of the invention, as best seen in FIGS. 1-3 of the drawings, provides for a reduced area of exposed electrode 11B reducing the possibility of arc wander in a variety of welding orientations. The electrode sleeve 18, in this example, is formed from ceramic material capable of withstanding high temperatures associated with arc welding. The electrode sleeve 18 has a tubular elongated body member 19 with an exterior spiral flight 20 formed thereon. Flight 20 provides for additional heat dissipation by increasing surface area during use. The flight 19 extends the length of the body member 18 which has an interior open diameter to accommodate the exterior diameter of a tungsten electrode 11 which is slidably positioned therein.

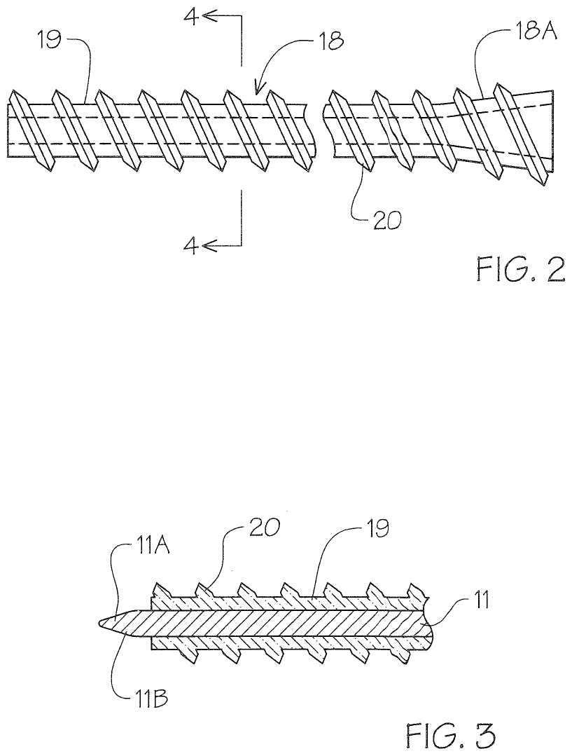

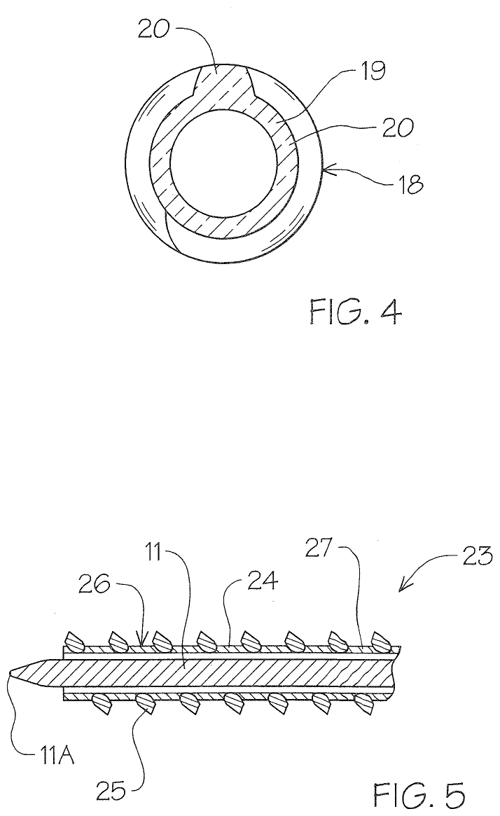

The electrode 11 achieves a friction fit within the electrode sleeve 18 and is further secured in place by the expansion of the electrode 11 as it is heated by the high temperature arc formed therefrom. A gas circulation sleeve flare portion 18A, as seen in FIGS. 2 and 7 of the drawings, provides end sleeve ventilation indicated by flow arrow F to provide additional cooling thereto.

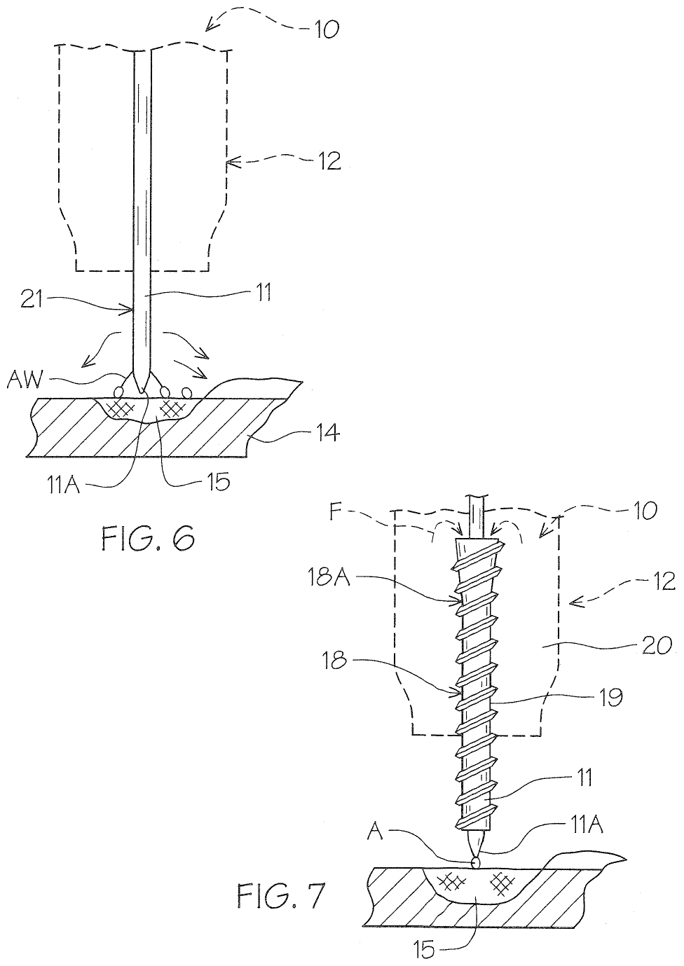

Referring now to FIGS. 6 and 7 of the drawings, a graphic illustration of arc directional comparison can be seen with the indication of possible arc wandering AW in FIG. 6 of the drawings given the effective exposed surface of the electrode 11 indicated at 21 with the possibility of arc dimensional variation illustrated by directional flow arrows.

In contrast, FIG. 7 of the drawings illustrates the electrode 11 being fitted within the ceramic isolation sleeve 18 of the invention thereby limiting the arc formation to a proper direct path from the exposed surface for a controlled effective weld joint 17 formation within the given parameters of the weld equipment, not shown, as to amperage and current flow configuration, well known to those skilled in the art.

Referring now to FIG. 5 of the drawings, an alternate isolation sleeve 23 of the invention can be seen wherein an elongated ceramic body 24 with an exterior flight 25 formed on both the exterior 26 of the sleeve body 24 and by its formation within the interior of the sleeve indicated at 27 having the same sleeve flared end, not shown, as the primary sleeve 18.

This alternate isolation sleeve configuration 23 thereby provides select continuous spiral interface retainment engagement surface of the sleeve at 28 with the exterior of the electrode 11 onto which it is places for surface isolation and retainment.

It will be evident that in both the primary and alternate form of the invention that the ceramic isolation sleeves 18 and 23 shield the sides of the tungsten electrode 11 allowing only the very end tip 11A to generate the controlled arc A allowing for the user, not shown, to maintain a wander free arc in different weld situations, as noted.

The respective ceramic isolation sleeves 17 and 23 can be produced at whatever length and inside diameter is required to meet the configuration of the electrode being used thereon.

Thus it will be seen that a new and novel isolation electrode sleeve for TIG welding has been illustrated and described and it will be apparent to those skilled in the art that various changes and modifications many be made therein without departing from the spirit of the invention.

Therefore, I claim:

1. An arc welding process employing a TIG torch with a non-consumable electrode and a consumable filler rod having an electrode isolation sleeve, said isolation sleeve comprises,
an elongated open end tubular body member positioned over a portion of said electrode,
a heat dissipation formation on said tubular body member, end opening of said tubular body member is of an interior diameter to receive said electrode there within,
said electrode of a length greater than that of said electrode isolation sleeve.

2. The arc welding process employing a TIG torch set forth in claim 1 wherein said heat dissipation formation on said isolation tubular body member is a spiral flight extending therefrom and whereabout.

3. The arc welding process employing a TIG torch set forth in claim 1 wherein said heat dissipation formation on said isolation tubular body member further comprises a tubular flare end of increased diameter.

4. The arc welding process employing a TIG torch set forth in claim 1 wherein said non-consumable electrode end extending from said isolation sleeve defines electric arc formation therefrom to a work piece to be welded.

5. The arc welding process employing a TIG torch set forth in claim 1 wherein said non-consumable electrode is tungsten material and said isolation sleeve open ended tubular body is formed of ceramic material.

6. The arc welding process employing a TIG torch set forth in claim 1 wherein the electrode isolation sleeve tubular body member interior has raised surfaces engaged on said non-consumable electrode secured there within.

7. The arc welding process employing a TIG torch set forth in claim 3 wherein said electrode arc formed is free from wander being directed directly to said work piece from said electrode end extending from said isolation sleeve to form a weld thereon.
